(19) United States
(12) Patent Application Publication
(10) Pub. No.: US 2024/0429582 A1
(43) Pub. Date: Dec. 26, 2024

(54) METHOD FOR MANUFACTURING ELECTRICITY STORAGE DEVICE

(71) Applicant: Prime Planet Energy & Solutions, Inc., Tokyo (JP)

(72) Inventor: Naoki MASUZAWA, Toyota-shi (JP)

(21) Appl. No.: 18/736,535

(22) Filed: Jun. 7, 2024

(30) Foreign Application Priority Data
Jun. 23, 2023 (JP) 2023-102887

(51) Int. Cl. H01M 50/664

(52) U.S. Cl. CPC H01M 50/664

(57) ABSTRACT

The present disclosure provides a method for manufacturing an electricity storage device that includes a lid including a pouring hole and closing an opening of a case body. The method includes: a temporary sealing step involving affixing an adhesive tape to the lid such that the pouring hole is closed; and an unsealing step involving peeling off the adhesive tape affixed to the lid. The temporary sealing step involves bringing the adhesive tape into intimate contact with a peripheral edge of the pouring hole of the lid, and causing a portion of the adhesive tape located at a distance from the pouring hole to be at least partially lifted from the lid.

### CROSS REFERENCE TO RELATED APPLICATION

This application claims the benefit of priority to Japanese Patent Application No. 2023-102887 filed on Jun. 23, 2023. The entire contents of this application are hereby incorporated herein by reference.

### BACKGROUND OF THE DISCLOSURE

### 1. Field

The present disclosure relates to methods for manufacturing electricity storage devices.

### 2. Background

A typical electricity storage device includes: an electrode assembly; an electrolytic solution; a case body including an opening and containing the electrode assembly and the electrolytic solution; and a lid including a pouring hole and closing the opening of the case body (see, for example, JP 2022-139497 A and JP 2017-117657 A).

JP 2022-139497 A, for example, discloses an electricity storage device manufacturing method including the steps of: temporarily sealing a pouring hole with a first sealing member (which is an air-permeable film); impregnating an electrode assembly with an electrolytic solution, with the pouring hole temporarily sealed with the first sealing member; removing the first sealing member so as to unseal the pouring hole; and finally sealing the pouring hole with a second sealing member (which is a sealing stopper).

### SUMMARY

Studies conducted by the inventor of the present disclosure suggest that, because the first sealing member for use in temporary sealing is an adhesive tape, firmly affixing the adhesive tape to a lid may make it difficult to peel off the adhesive tape in a subsequent or later step. As also mentioned in JP 2022-139497 A, another disadvantage is that an adhesive substance may remain on the lid after the adhesive tape is peeled off. This may unfortunately result in difficulty in fitting the second sealing member to the pouring hole during final sealing.

Accordingly, embodiments of the present disclosure provide electricity storage device manufacturing methods that are able to further facilitate peeling off adhesive tapes after temporary sealing.

An embodiment of the present disclosure provides a method for manufacturing an electricity storage device including: an electrode assembly; an electrolytic solution; a case body including an opening and containing the electrode assembly and the electrolytic solution; and a lid including a pouring hole and closing the opening of the case body. The method includes: a temporary sealing step involving affixing an adhesive tape to the lid such that the pouring hole is closed; and an unsealing step involving peeling off the adhesive tape affixed to the lid. The temporary sealing step involves affixing the adhesive tape to a peripheral edge of the pouring hole, and causing a portion of the adhesive tape located at a distance from the pouring hole to be at least partially lifted from the lid.

As a result of conducting extensive studies, the inventor of the present disclosure has found new facts described below. When an adhesive tape is to be peeled off from a lid, an end edge of the adhesive tape is often caught with the tips of fingernails or a gripper (such as tweezers) so as to pull up the adhesive tape. If the end edge of the adhesive tape is firmly stuck to the lid, however, the end edge of the adhesive tape resists being caught with, for example, the tips of fingernails. This requires a large external force at a peeling starting point, making it likely that an adhesive substance, in particular, will remain on the lid (i.e., making it likely that an adhesive residue will be left on the lid).

To solve these problems, the temporary sealing step according to the embodiment of the present disclosure involves causing a portion of the adhesive tape located at a distance from the pouring hole to be lifted from the lid. This facilitates, during the unsealing step, peeling off of the adhesive tape, which starts from the portion of the adhesive tape lifted from the lid. Accordingly, the embodiment of the present disclosure requires a less external force at a peeling starting point. Consequently, the embodiment of the present disclosure makes it difficult for an adhesive substance to remain around the pouring hole after the adhesive tape is peeled off, and thus facilitates fitting a sealing member to the pouring hole.

The above and other elements, features, steps, characteristics, and advantages of the present disclosure will become more apparent from the following detailed description of the preferred embodiments with reference to the attached drawings.

### BRIEF DESCRIPTION OF THE DRAWINGS

FIG. 1 is a schematic perspective view of an electricity storage device according to an embodiment of the present disclosure.

FIG. 2 is a schematic perspective view of an electrode assembly.

FIG. 3 is a schematic diagram illustrating a structure of the electrode assembly.

FIG. 4 is a flow chart illustrating a manufacturing method according to the embodiment of the present disclosure.

FIG. 5 is a schematic side view of main components of a tape affixing apparatus.

FIGS. 6A to 6F are schematic diagrams illustrating a temporary sealing step.

FIG. 7A is a schematic plan view of a lid after the temporary sealing step.

FIG. 7B is a schematic vertical sectional view of the lid taken along the line VII(B)-VII(B) in FIG. 7A.

FIG. 8 is a schematic diagram illustrating an unsealing step.

FIG. 9 is a schematic diagram illustrating an unsealing step according to one variation.

### DETAILED DESCRIPTION OF THE PREFERRED EMBODIMENTS

Preferred embodiments of techniques disclosed herein will be described below with reference to the drawings. Matters other than those specified herein but necessary for carrying out the present disclosure (e.g., common electricity storage device structures and manufacturing processes that do not characterize the techniques disclosed herein) may be understood by those skilled in the art as design matters based on techniques known in the related art. The techniques disclosed herein may be carried out on the basis of the description given herein and common technical knowledge in the related art.

As used herein, the term “electricity storage device” refers to any of various devices that are repeatedly chargeable and dischargeable. The term “electricity storage device” is a concept that subsumes not only storage batteries, such as lithium ion secondary batteries and nickel-metal hydride batteries, but also capacitors, such as lithium ion capacitors and electric double layer capacitors. Unless otherwise stated, any numerical range between “A” and “B” used herein (where A is a numerical value representing the lower limit of the range and B is a numerical value representing the upper limit of the range) may be inclusive of A and B, or may be greater than A and less than B.

### Electricity Storage Device 100

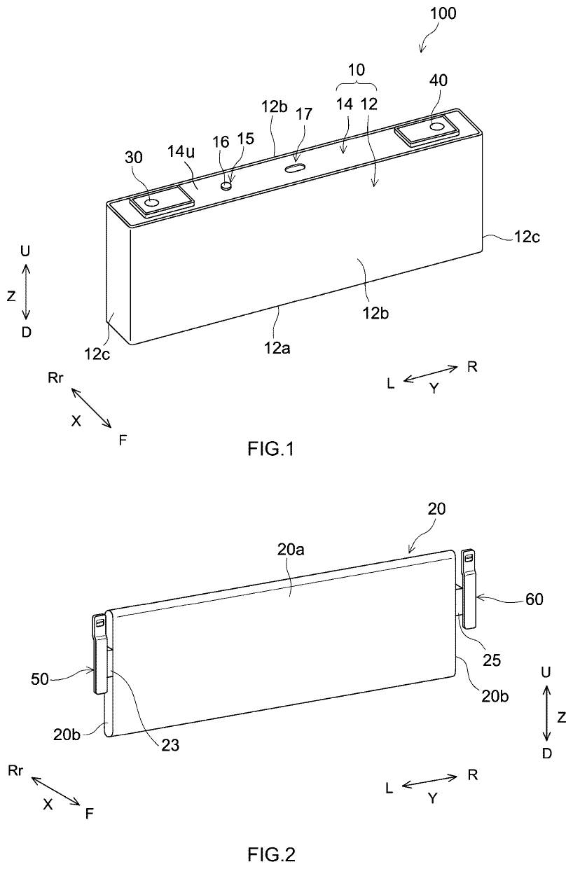

First, an electricity storage device 100 manufactured by a manufacturing method disclosed herein will be described. FIG. 1 is a perspective view of the electricity storage device 100. In the following description, the reference sign X represents a “short side direction” of the electricity storage device 100, the reference sign Y represents a “long side direction” of the electricity storage device 100 perpendicular or substantially perpendicular to the short side direction X, and the reference sign Z represents a “height direction” of the electricity storage device 100 perpendicular or substantially perpendicular to the short side direction X and the long side direction Y. The reference signs F and Rr associated with the short side direction X respectively represent “front” and “rear”. The reference signs L and R associated with the long side direction Y respectively represent “left” and “right”. The reference signs U and D associated with the height direction Z respectively represent “up” and “down”. These directions, however, are defined merely for the sake of convenience of description and do not limit in any way how the electricity storage device 100 may be installed.

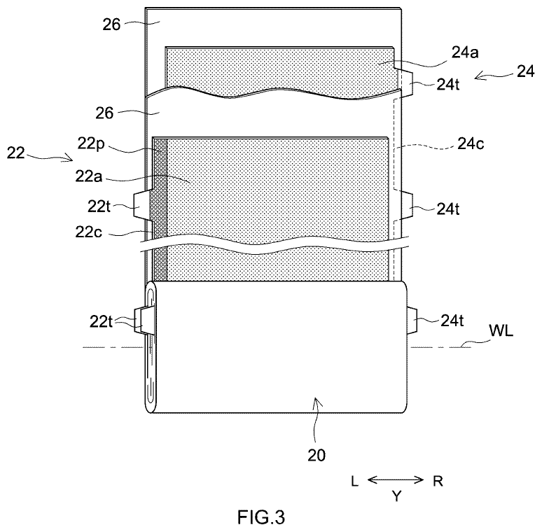

As illustrated in FIG. 1, the electricity storage device 100 includes a battery case 10. The electricity storage device 100 further includes an electrode assembly 20 (see FIGS. 2 and 3) and an electrolytic solution (not illustrated). In this embodiment, the electricity storage device 100 is a lithium ion secondary battery.

The battery case 10 includes: a case body 12 including an opening; and a lid (which may be a sealing plate) 14 closing the opening. The lid 14 is joined to a peripheral edge of the opening of the case body 12. The case body 12 and the lid 14 are thus integral with each other, with the result that the battery case 10 is sealed airtightly (or hermetically). In this embodiment, the battery case 10 has a flat cuboidal shape (or a flat rectangular shape) with a bottom. Alternatively, the battery case 10 may have any other suitable shape, such as a cubic shape or a circular cylindrical shape.

The case body 12 is a casing that contains the electrode assembly 20 and the electrolytic solution. The case body 12 includes a rectangular bottom surface 12a, a pair of wide surfaces 12b, and a pair of narrow surfaces 12c. The wide surfaces 12b each extend upward from an associated one of two long sides of the bottom surface 12a. The narrow surfaces 12c each extend upward from an associated one of two short sides of the bottom surface 12a. The lid 14 is a flat plate member. The lid 14 faces the bottom surface 12a of the case body 12. The lid 14 includes an upper surface 14u. The upper surface 14u is a surface of the lid 14 located at a distance from the case body 12 and defines an outer surface of the battery case 10. In this embodiment, the lid 14 has a substantially rectangular shape. As used herein, the term “substantially rectangular shape” refers to not only a perfect rectangular shape (or a perfect oblong shape) but also various other rectangular shapes, such as a rectangular shape whose corners connecting long and short sides are rounded and a rectangular shape whose corners have cut-outs.

The lid 14 is provided with a pouring hole 15, a safety valve 17, a positive electrode external terminal 30, and a negative electrode external terminal 40. The pouring hole 15 is a through hole through which the electrolytic solution is poured into the battery case 10 after the lid 14 is assembled to the case body 12. In this embodiment, the pouring hole 15 has a circular shape in a plan view. The pouring hole 15 is sealed with a sealing member 16. The sealing member 16 is preferably a sealing stopper including a portion insertable into the pouring hole 15. The safety valve 17 is a thin portion configured to, when a pressure inside the battery case 10 is equal to or higher than a predetermined value, rupture such that gas inside the battery case 10 is discharged out of the battery case 10. The positive electrode external terminal 30 and the negative electrode external terminal 40 are electrically connected to the electrode assembly 20 housed in the battery case 10.

The battery case 10 may be made of any suitable material. In one example, the battery case 10 is made of metal. Examples of metallic materials for the battery case 10 include aluminum, an aluminum alloy, iron, and an iron alloy. Alternatively, the battery case 10 may be made of a heat-resistant resin material, such as polyimide resin.

The electrode assembly 20 (see FIGS. 2 and 3) is housed in the battery case 10 (or specifically, in the case body 12). Any suitable number of electrode assemblies 20 may be disposed in one battery case 10. One electrode assembly 20 or two or more electrode assemblies 20 (i.e., more than one electrode assembly 20) may be disposed in one battery case 10.

FIG. 2 is a perspective view of the electrode assembly 20. FIG. 3 is a schematic diagram illustrating a structure of the electrode assembly 20. As illustrated in FIGS. 2 and 3, a positive electrode internal terminal 50 and a negative electrode internal terminal 60 are attached to the electrode assembly 20. The positive electrode internal terminal 50 is connected to the positive electrode external terminal 30 (see FIG. 1). The negative electrode internal terminal 60 is connected to the negative electrode external terminal 40 (see FIG. 1).

As illustrated in FIG. 3, the electrode assembly 20 includes a positive electrode 22 and a negative electrode 24. In this embodiment, the electrode assembly 20 is a flat wound electrode assembly provided by placing the strip-shaped positive and negative electrodes 22 and 24 in layers, with strip-shaped separators 26 interposed therebetween, and winding the positive and negative electrodes 22 and 24 and the separators 26 around a winding axis WL. As illustrated in FIG. 2, the electrode assembly 20 includes: a pair of flat portions 20a whose outer surfaces are flat; and a pair of curved portions 20b whose outer surfaces are curved. Alternatively, the electrode assembly 20 may be a laminated electrode assembly including quadrangular positive and negative electrodes (which are typically rectangular positive and negative electrodes) stacked on top of another such that the positive and negative electrodes are insulated from each other.

Although not illustrated in detail, the electrode assembly 20 is disposed in the case body 12 such that the winding axis WL extends in parallel or substantially in parallel with the long side direction Y. With the electrode assembly 20 housed in the battery case 10 (see FIG. 1), the pair of flat portions 20a of the electrode assembly 20 faces the wide surfaces 12b of the battery case 10, and the pair of curved portions 20b of the electrode assembly 20 faces the narrow surfaces 12c of the battery case 10.

The positive electrode 22 includes: a strip-shaped positive electrode collector foil 22c (which is, for example, aluminum foil); and a positive electrode active material layer 22a fixed onto at least one of surfaces of the positive electrode collector foil 22c. The positive electrode 22 may be further provided with any other suitable layer(s). When necessary, one of lateral edge portions of the positive electrode 22 in the long side direction Y may be provided with a positive electrode protective layer 22p as illustrated in FIG. 3. Material(s) for the positive electrode active material layer 22a and/or the positive electrode protective layer 22p may be any suitable material(s) used for any electricity storage device of the type disclosed herein (which may be a lithium ion secondary battery in the present embodiment). The material(s) for the positive electrode active material layer 22a and/or the positive electrode protective layer 22p do/does not characterize the techniques disclosed herein and will thus not be described in detail.

One end portion of the positive electrode collector foil 22c in the long side direction Y (i.e., a left end portion of the positive electrode collector foil 22c in FIG. 3) is provided with positive electrode tabs 22t. The positive electrode tabs 22t each protrude to a first side in the long side direction Y (i.e., leftward in FIG. 3). The positive electrode tabs 22t are spaced from each other (or provided at intervals) in a longitudinal direction of the positive electrode 22. The positive electrode tabs 22t are portions of the positive electrode collector foil 22c. Specifically, the positive electrode tabs 22t are exposed portions of the positive electrode collector foil 22c where no positive electrode active material layer 22a or positive electrode protective layer 22p is provided. The positive electrode tabs 22t are placed in layers on one end portion of the positive electrode collector foil 22c in the long side direction Y (i.e., on the left end portion of the positive electrode collector foil 22c in FIG. 3) so as to form a positive electrode tab group 23. The positive electrode internal terminal 50 is joined to the positive electrode tab group 23 (see FIG. 2).

The negative electrode 24 includes: a strip-shaped negative electrode collector foil 24c (which is, for example, copper foil); and a negative electrode active material layer 24a fixed onto at least one of surfaces of the negative electrode collector foil 24c. A material for the negative electrode active material layer 24a may be any suitable material used for any electricity storage device of the type disclosed herein (which may be a lithium ion secondary battery in the present embodiment). The material for the negative electrode active material layer 24a does not characterize the techniques disclosed herein and will thus not be described in detail.

One end portion of the negative electrode collector foil 24c in the long side direction Y (i.e., a right end portion of the negative electrode collector foil 24c in FIG. 3) is provided with negative electrode tabs 24t. The negative electrode tabs 24t each protrude to a second side in the long side direction Y (i.e., rightward in FIG. 3). The negative electrode tabs 24t are spaced from each other (or provided at intervals) in a longitudinal direction of the negative electrode 24. In this embodiment, the negative electrode tabs 24t are portions of the negative electrode collector foil 24c. Specifically, the negative electrode tabs 24t are exposed portions of the negative electrode collector foil 24c where no negative electrode active material layer 24a is provided. The negative electrode tabs 24t are placed in layers on one end portion of the negative electrode collector foil 24c in the long side direction Y (i.e., on the right end portion of the negative electrode collector foil 24c in FIG. 3) so as to form a negative electrode tab group 25. The negative electrode internal terminal 60 is joined to the negative electrode tab group 25 (see FIG. 2).

Typically, the electrolytic solution is a nonaqueous electrolytic solution containing a nonaqueous solvent and a supporting electrolyte. The nonaqueous solvent may be any of various nonaqueous solvents used for electrolytic solutions in electricity storage devices of the type disclosed herein (which may be a lithium ion secondary battery in this embodiment). The supporting electrolyte may be any of various supporting electrolytes used for electrolytic solutions in electricity storage devices of the type disclosed herein (which may be a lithium ion secondary battery in this embodiment). Examples of the nonaqueous solvent include carbonates, such as ethylene carbonate (EC), diethyl carbonate (DEC), dimethyl carbonate (DMC), and ethyl methyl carbonate (EMC). Examples of the supporting electrolyte include a lithium salt, such as lithium hexafluorophosphate (LiPF₆). When necessary, the electrolytic solution may contain any of additives known in the art, such as a film former, a thickener, and a dispersant.

### Method for Manufacturing Electricity Storage Device 100

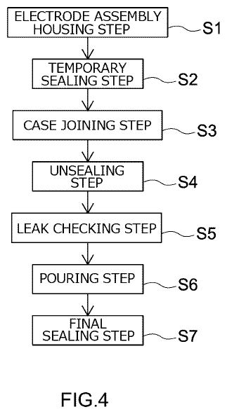

FIG. 4 is a flow chart illustrating the manufacturing method according to the present embodiment. The manufacturing method illustrated in FIG. 4 includes an electrode assembly housing step (step S1), a temporary sealing step (step S2), a case joining step (step S3), an unsealing step (step S4), a leak checking step (step S5), a pouring step (step S6), and a final sealing step (step S7) in this order. The flow chart of FIG. 4, however, merely illustrates an example of the techniques disclosed herein. The temporary sealing step (step S2) and the unsealing step (step S4) may be performed at timings other than those illustrated in the flow chart of FIG. 4. The temporary sealing step (step S2) and the electrode assembly housing step (step S1) may be reversed in order. The leak checking step (step S5) is an optional step. The manufacturing method may further include any other suitable step(s) at any stage(s).

The electrode assembly housing step (step S1) involves preparing the electrode assembly 20 and housing the electrode assembly 20 in the battery case 10. The electrode assembly housing step (step S1) preferably includes an electrode fabricating step (step S11), an electrode assembly fabricating step (step S12), and a housing step (step S13). The electrode assembly housing step (step S1) may further include any other suitable step(s) at any stage(s).

First, the electrode fabricating step (step S1l) involves fabricating each of the positive electrode 22 and the negative electrode 24 by using a method known in the art. In one example, the positive electrode 22 may be fabricated by: mixing a positive electrode active material, a conductive material, a binder, and a dispersing solvent so as to prepare a positive electrode mixture slurry; applying and drying the prepared positive electrode mixture slurry on the positive electrode collector foil 22c by using a method known in the art; and pressing the positive electrode mixture slurry as appropriate. In one example, the negative electrode 24 may be fabricated by: mixing a negative electrode active material, a binder, a dispersant, and a dispersing solvent so as to prepare a negative electrode mixture slurry; applying and drying the prepared negative electrode mixture slurry on the negative electrode collector foil 24c by using a method known in the art; and pressing the negative electrode mixture slurry as appropriate. Although the present embodiment involves fabricating both of the positive electrode 22 and the negative electrode 24, the positive electrode 22 and/or the negative electrode 24 may alternatively be prepared by purchasing commercially available electrode(s).

The electrode assembly fabricating step (step S12) involves fabricating the electrode assembly 20 by placing the positive and negative electrodes 22 and 24, which have been fabricated in the electrode fabricating step (step S11), such that the positive and negative electrodes 22 and 24 face each other, with the separator(s) 26 interposed therebetween. When the electrode assembly 20 to be fabricated is a flat wound electrode assembly, the electrode assembly fabricating step (step S12) includes, for example, a winding step, a pressing step, an internal terminal attaching step, an external terminal attaching step, and a collector joining step. First, the winding step involves placing the strip-shaped positive and negative electrodes 22 and 24 in layers, with the strip-shaped separators 26 interposed therebetween, and then involves winding the positive and negative electrodes 22 and 24 and the separators 26 around the winding axis WL into a cylindrical shape. The pressing step involves pressing the cylindrically wound electrode assembly into a flat shape. The internal terminal attaching step involves attaching the positive electrode internal terminal 50 to the positive electrode tab group 23 of the electrode assembly 20, and attaching the negative electrode internal terminal 60 to the negative electrode tab group 25 of the electrode assembly 20. The external terminal attaching step involves attaching the positive electrode external terminal 30 and the negative electrode external terminal 40 to the lid 14. The collector joining step involves respectively joining the positive electrode internal terminal 50 and the negative electrode internal terminal 60 to the positive electrode external terminal 30 and the negative electrode external terminal 40 by a method known in the art. The electrode assembly 20 and the lid 14 are thus integral with each other.

The housing step (step S13) involves fitting the lid 14, which is integral with the electrode assembly 20, to the opening of the case body 12. The electrode assembly 20 is thus housed in the case body 12.

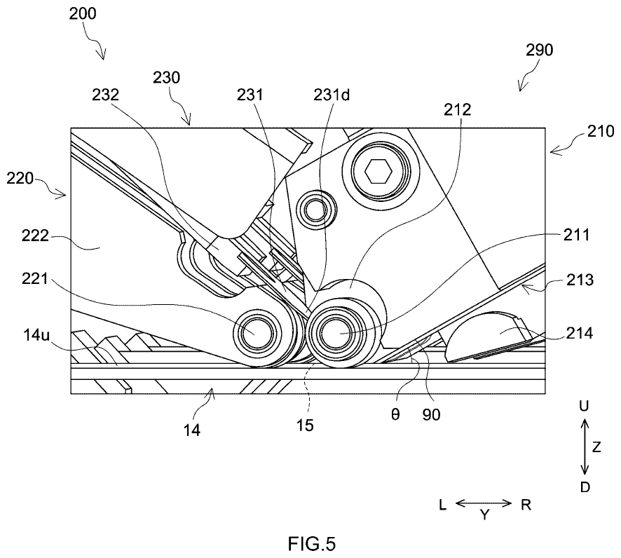

The temporary sealing step (step S2) involves affixing an adhesive tape 90 (see FIG. 5) to the lid 14 such that the pouring hole 15 of the lid 14 is closed. The adhesive tape 90 is wider than the pouring hole 15. Typically, the adhesive tape 90 is in a rolled form. Although the adhesive tape 90 may have any suitable average thickness, the adhesive tape 90 may have an average thickness of about 1000 μm or less, and may typically have an average thickness of 500 μm or less (e.g., 250 μm or less). When spatters are produced during the subsequent case joining step (step S3), the adhesive tape 90 prevents the spatters from entering into the case body 12 through the pouring hole 15.

The adhesive tape 90 typically includes: a base layer; and an adhesive layer that is provided on a surface of the base layer facing the lid 14 and is adherable to the lid 14. Although the base layer may be made of any suitable material, the base layer is preferably made of a resin material, such as polyimide resin (e.g., Kapton®), fluorine resin, or polyethylene terephthalate (PET), or a glass material, such as glass cloth. The base layer is more preferably made of a resin material. The base layer is particularly preferably made of polyimide resin or fluorine resin, because such a resin material is highly resistant to (or unlikely to be burnt by) heat from spatters.

FIG. 5 is a schematic side view of main components of a tape affixing apparatus 200 used in the temporary sealing step (step S2). The tape affixing apparatus 200 is disposed above the lid 14 and is configured to affix the adhesive tape 90 to a peripheral edge of the pouring hole 15 of the lid 14. Referring to FIG. 5, the following description discusses how the tape affixing apparatus 200 is to be used. Alternatively, the adhesive tape 90 may be affixed to the lid 14 by human hand (or manually) without the use of the tape affixing apparatus 200.

The tape affixing apparatus 200 includes an affixing unit 290. The affixing unit 290 is directly or indirectly supported by a supporting member (not illustrated). During standby, or while no affixing operation is being performed, the affixing unit 290 is located at a predetermined home position (not illustrated). The affixing unit 290 includes a tape feeder 210, a tape affixer 220, and a tape cutting device 230. The affixing unit 290 is configured to be movable from the home position to an affixing position located below the home position by an up-down direction mover (not illustrated). The affixing unit 290 is configured to be movable in the long side direction Y by a long side direction mover (not illustrated). The long side direction Y is an example of a “first direction extending along a surface of the lid”.

The up-down direction mover and the long side direction mover may be similar in structure, configuration, and/or arrangement to those known in the art. In one example, the up-down direction mover is a raising and lowering cylinder. The up-down direction mover is electrically connected to a controller (not illustrated). Upon actuation of the raising and lowering cylinder, the tape feeder 210, the tape affixer 220, and the tape cutting device 230 of the affixing unit 290 are moved together toward the lid 14 (i.e., to the affixing position).

The long side direction mover includes, for example, a guide rail extending in the long side direction Y, and a drive motor. The affixing unit 290 is in slidable engagement with the guide rail. The drive motor is connected to the affixing unit 290 through, for example, a ball screw. The drive motor is electrically connected to the controller (not illustrated). Upon rotation of the drive motor, the tape feeder 210, the tape affixer 220, and the tape cutting device 230 of the affixing unit 290 are moved together in the long side direction Y along the guide rail. When moving forward in the direction of travel, the affixing unit 290 moves rightward in FIG. 5. When moving rearward in the direction of travel, the affixing unit 290 moves leftward in FIG. 5.

The tape feeder 210 is configured to feed the adhesive tape 90 to an affixing roller 221 (which will be described below). The tape feeder 210 is disposed rightward of the affixing roller 221 (i.e., forward of the affixing roller 221 in the direction of travel). The tape feeder 210 includes: a feeding reel (not illustrated) around which the adhesive tape 90 is wound; a guide roller 211; a roller supporting member 212 supporting the guide roller 211; a tape feeding path 213; a tape chuck 214; and a feeder mover (not illustrated). The feeder mover causes the tape feeder 210 to move upward from the affixing position solely (i.e., separately from the tape affixer 220 and the tape cutting device 230). The feeder mover is not limited to any particular structure, configuration, or arrangement. In one example, the feeder mover is a drive motor. In this case, actuating the drive motor moves the roller supporting member 212 in the up-down direction. The up-down movement of the roller supporting member 212 moves the guide roller 211 in the up-down direction.

The guide roller 211 unwinds the adhesive tape 90 from the feeding reel and guides the adhesive tape 90 to a position close to the affixing roller 221. The guide roller 211 has a long circular cylindrical shape. The guide roller 211 is disposed such that its axis extends in the short side direction X. The guide roller 211 is supported by the roller supporting member 212 such that the guide roller 211 is rotatable around its axis extending in the short side direction X. The guide roller 211 may be configured to be rotated by, for example, a motor connected to the guide roller 211. The length of the guide roller 211 in the short side direction X is typically longer than the width of the adhesive tape 90 (i.e., the length of the adhesive tape 90 in the short side direction X). The length of the guide roller 211 in the short side direction X may be shorter than the width of the lid 14 (i.e., the length of the lid 14 in the short side direction X).

The tape feeding path 213 is a path along which the adhesive tape 90 runs such that the adhesive tape 90, which has been unwound from the feeding reel, is passed onto the guide roller 211. In this embodiment, the tape feeding path 213 is a guide rail extending along a lower surface of the roller supporting member 212. As illustrated in FIG. 5, an angle θ formed between the tape feeding path 213 and the upper surface 14u of the lid 14 at the affixing position is preferably between 20° and 50°. This facilitates affixing the adhesive tape 90 to the upper surface 14u of the lid 14.

The tape feeding path 213 is provided with a suction arrangement. In this embodiment, the tape feeding path 213 is provided with suction holes through which the adhesive tape 90 is suctioned onto the guide rail. The suction holes are connected to a suction pump (not illustrated). The suction pump is electrically connected to the controller (not illustrated). Actuation of the suction pump depressurizes a space between the tape feeding path 213 and the adhesive tape 90 through the suction holes. The adhesive tape 90 is thus suctioned and fixed onto the tape feeding path 213.

The tape chuck 214 is provided at a location somewhere along the tape feeding path 213. At normal times, the tape chuck 214 is in a closed state and supports, from below, the adhesive tape 90 suctioned and fixed onto the tape feeding path 213. The tape chuck 214 is configured to be moved downward by a suitable arrangement (not illustrated) and opened automatically at the time of an affixing operation.

The tape affixer 220 is configured to affix the adhesive tape 90 to the upper surface 14u of the lid 14. The tape affixer 220 includes: the affixing roller 221; a roller supporting member 222 supporting the affixing roller 221; and an affixer mover (not illustrated). The affixer mover moves the affixing roller 221 upward from the affixing position. The affixer mover is not limited to any particular structure, configuration, or arrangement. In one example, the affixer mover is a drive motor. In this case, actuating the drive motor moves the roller supporting member 222 in the up-down direction. The up-down movement of the roller supporting member 222 moves the affixing roller 221 in the up-down direction.

The affixing roller 221 presses the adhesive tape 90 against the upper surface 14u of the lid 14. The affixing roller 221 is disposed side by side with the tape feeder 210 (or specifically, the guide roller 211) in the long side direction Y. The affixing roller 221 is disposed leftward of the tape feeder 210 (i.e., rearward of the tape feeder 210 in the direction of travel). The affixing roller 221 has a long circular cylindrical shape. The affixing roller 221 is disposed such that its axis extends in the short side direction X. The affixing roller 221 is supported by the roller supporting member 222 such that the affixing roller 221 is rotatable around its axis extending in the short side direction X. The affixing roller 221 may be configured to be rotated by, for example, a motor connected to the affixing roller 221. The length of the affixing roller 221 in the short side direction X is typically longer than the width of the adhesive tape 90 (i.e., the length of the adhesive tape 90 in the short side direction X). The length of the affixing roller 221 in the short side direction X may be shorter than the width of the lid 14 (i.e., the length of the lid 14 in the short side direction X). The affixing roller 221 may be configured to press, with an urger (such as a spring), the adhesive tape 90 against the upper surface 14u of the lid 14 more firmly than the guide roller 211.

The tape cutting device 230 includes: a cutter 231; a cutter supporting member 232 supporting the cutter 231; a cutter mover (not illustrated); and a cutting arrangement (not illustrated). The cutter mover moves the cutter 231 upward from the affixing position. The cutter mover is not limited to any particular structure, configuration, or arrangement. In one example, the cutter mover is a drive motor. In this case, actuating the drive motor moves the cutter supporting member 232 in the up-down direction. The cutting arrangement moves the cutter 231 from the affixing position to a cutting position located obliquely below the affixing position. The cutting arrangement is not limited to any particular structure, configuration, or arrangement. In one example, the cutting arrangement is a piston cylinder. In this case, actuating the piston cylinder reciprocates the cutter 231 between the affixing position and the cutting position located obliquely below the affixing position so as to cut the adhesive tape 90.

The cutter 231 is a member to cut the adhesive tape 90. The cutter 231 extends obliquely downward toward the upper surface 14u of the lid 14. At the affixing position, a lower end 231d of the cutter 231 is located at substantially the same height as an upper end of the guide roller 211 and an upper end of the affixing roller 221. At the affixing position, the lower end 231d of the cutter 231 is located between the guide roller 211 and the affixing roller 221 in the long side direction Y.

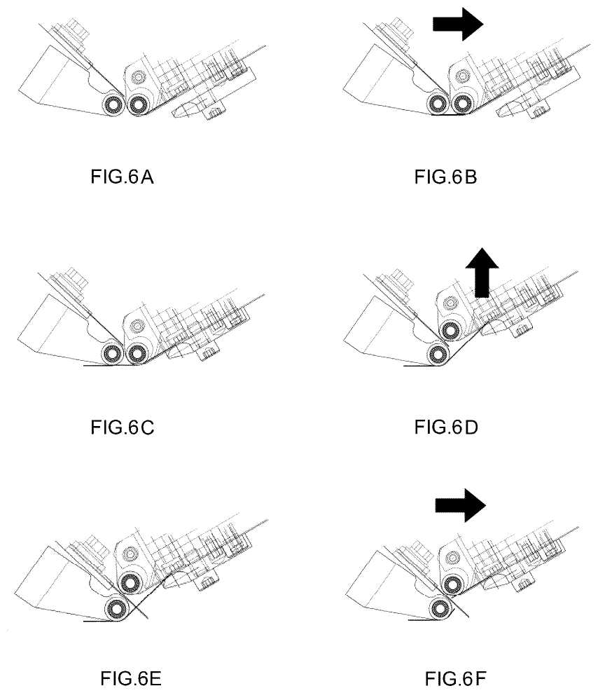

FIGS. 6A to 6F are schematic diagrams illustrating the temporary sealing step (step S2). In FIGS. 6A to 6F, the lid 14 is not illustrated. Because no reference signs are presented in FIGS. 6A to 6F, see FIG. 5 to check the reference signs assigned to the components of the tape affixing apparatus 200. As illustrated in FIG. 5, the temporary sealing step (step S2) first involves causing the up-down direction mover to move the affixing unit 290 (i.e., the tape feeder 210, the tape affixer 220, and the tape cutting device 230) from the home position to the affixing position. The movement of the affixing unit 290 from the home position to the affixing position brings lower ends of the guide roller 211 and the affixing roller 221 into abutment with the upper surface 14u of the lid 14. When the guide roller 211 is configured to be rotated by, for example, a motor, however, the guide roller 211 does not necessarily have to be brought into abutment with the upper surface 14u of the lid 14. During the movement of the affixing unit 290 from the home position to the affixing position, the tape chuck 214 of the tape feeder 210 is in a closed state, and the suction pump is being activated, so that the adhesive tape 90 is fixed onto the tape feeding path 213.

As illustrated in FIG. 6A, the temporary sealing step (step S2) subsequently involves opening the tape chuck 214 of the tape feeder 210 and deactivating the suction pump, although not illustrated in FIG. 6A. In this state, an affixing operation is performed. Specifically, as indicated by the arrow in FIG. 6B, the long side direction mover moves the affixing unit 290 in a first direction (i.e., from left to right in the long side direction Y) by a predetermined first distance. The first distance is longer than the length of the pouring hole 15 in the long side direction Y. The movement of the affixing unit 290 in the first direction by the first distance causes rotation of the guide roller 211, which unwinds the adhesive tape 90 from the feeding reel in accordance with the first distance and guides the adhesive tape 90 to a position close to the affixing roller 221 through the tape feeding path 213. The adhesive tape 90 is thus sequentially fed to the affixing roller 221. The adhesive tape 90 is pressed against the upper surface 14u of the lid 14 by the affixing roller 221 and affixed to the upper surface 14u such that the pouring hole 15 is closed with the adhesive tape 90. In FIG. 6B, the angle θ formed between the tape feeding path 213 and the lid 14 is between 20° and 50° during the affixing operation. Accordingly, the adhesive tape 90 is suitably affixed to the upper surface 14u of the lid 14 in a stable manner.

As illustrated in FIG. 6C, the temporary sealing step (step S2) then involves closing the tape chuck 214 of the tape feeder 210 and activating the suction pump. The adhesive tape 90 is thus fixed onto the tape feeding path 213 again. As indicated by the arrow in FIG. 6D, the temporary sealing step (step S2) subsequently involves causing the feeder mover to move the roller supporting member 212 upward from the affixing position. In FIG. 6D, the roller supporting member 212 is moved upward such that the lower end of the guide roller 211 is located above the upper end of the affixing roller 221. This lifts a portion of the adhesive tape 90 located between the tape feeder 210 (or specifically, the tape chuck 214) and the affixing roller 221 from the tape feeding path 213. The lifted portion of the adhesive tape 90 assumes an obliquely upwardly extending position. Accordingly, the lifted portion of the adhesive tape 90 is urged to curl upward around the affixing roller 221. This makes it possible to more reliably lift the portion of the adhesive tape 90 from the tape feeding path 213.

As illustrated in FIG. 6E, the temporary sealing step (step S2) subsequently involves causing the cutting arrangement to move the cutter 231 to the cutting position located obliquely below the affixing position. At the cutting position, the lower end 231d of the cutter 231 is located below the lower end of the guide roller 211. At the cutting position, the lower end 231d of the cutter 231 is located at substantially the same height as the lower end of the affixing roller 221. At the cutting position, the lower end 231d of the cutter 231 is located rightward of the guide roller 211 in the long side direction Y (i.e., located forward of the guide roller 211 in the direction of travel). The adhesive tape 90 is thus cut between the tape feeder 210 (or specifically, the tape chuck 214) and the affixing roller 221. In FIG. 6E, the upward movement of the roller supporting member 212 causes the cutter 231 and the adhesive tape 90 to form a substantially right angle (i.e., an angle of 90°±5°) in a side view. This makes it possible to cut the adhesive tape 90 in a stabler manner.

As indicated by the arrow in FIG. 6F, the temporary sealing step (step S2) subsequently involves causing the long side direction mover to move the affixing unit 290 in the first direction (i.e., from left to right in the long side direction Y) by a predetermined second distance. Thus, the adhesive tape 90 that has undergone cutting and is located close to the affixing roller 221 is affixed to the upper surface 14u of the lid 14 by the affixing roller 221. The second distance is shorter than the total length of the lifted portion of the adhesive tape 90 that has undergone cutting. The second distance is typically shorter than the first distance. Pressing an end of a portion of the adhesive tape 90 affixed to the upper surface 14u of the lid 14 after cutting makes it possible to more successfully bring the adhesive tape 90 into intimate contact with the upper surface 14u of the lid 14. Upon completion of the operations described above, the cutter 231 is moved upward by the cutter mover, and the affixing roller 221 is moved upward from the affixing position by the affixer mover. Accordingly, a portion of the adhesive tape 90 that has undergone cutting is kept lifted from the upper surface 14u of the lid 14.

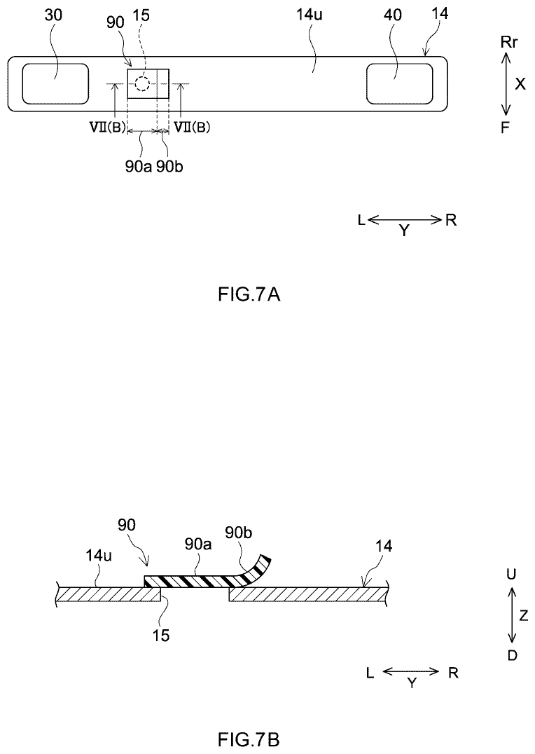

FIG. 7A is a schematic plan view of the upper surface 14u of the lid 14 after the temporary sealing step (step S2). FIG. 7B is a schematic vertical sectional view of the lid 14 taken along the line VII(B)-VII(B) in FIG. 7A. As illustrated in FIG. 7A, the adhesive tape 90 disposed on the upper surface 14u of the lid 14 has a substantially rectangular shape in the plan view. The adhesive tape 90 is disposed on the upper surface 14u of the lid 14 such that a direction in which the long sides of the substantially rectangular adhesive tape 90 extend corresponds to the long side direction Y of the electricity storage device 100. Alternatively, the adhesive tape 90 may have any other suitable shape in the plan view. The adhesive tape 90 is divided into two portions disposed side by side in the long side direction Y. Specifically, the adhesive tape 90 includes: a peripheral edge portion 90a surrounding the pouring hole 15; and an extended portion 90b extended from the peripheral edge portion 90a to the second side in the long side direction Y (i.e., extended forward in the direction of travel or rightward in FIG. 7A). The extended portion 90b is an example of a “portion of the adhesive tape located at a distance from the pouring hole”.

As illustrated in FIG. 7B, the peripheral edge portion 90a closes the pouring hole 15. The peripheral edge portion 90a of the adhesive tape 90 is disposed not only around the pouring hole 15 but also over the pouring hole 15. The peripheral edge portion 90a of the adhesive tape 90 is affixed to the upper surface 14u of the lid 14 and thus in intimate contact with the upper surface 14u of the lid 14. This makes it possible to prevent spatters from entering into the case body 12 through the pouring hole 15 during welding of the lid 14 to the case body 12 in the case joining step (step S3), which will be described below.

The extended portion 90b is located at a distance from the upper surface 14u of the lid 14 and thus lifted from the upper surface 14u of the lid 14. Because the adhesive tape 90 includes the extended portion 90b, a central position of the adhesive tape 90 is deviated rightward from a central position of the pouring hole 15 in the long side direction Y. This positional relationship is maintained until the adhesive tape 90 is removed in the unsealing step (step S4), which will be described below. Lifting a portion of the adhesive tape 90 (i.e., the extended portion 90b) from the upper surface 14u of the lid 14 in this manner facilitates, in the unsealing step (step S4), peeling off the adhesive tape 90 with the use of the portion of the adhesive tape 90 lifted from the lid 14 (i.e., the extended portion 90b).

Studies conducted by the inventor of the present disclosure suggest that when a reusable resin cap is cleaned and used repeatedly instead of the adhesive tape 90 in order to temporarily seal the pouring hole 15 as described in, for example, JP 2017-117657 A, foreign matter is gradually likely to adhere to a surface of the cap owing to friction, which may lead to contamination by the foreign matter. Another disadvantage is that repeatedly cleaning and/or using the cap may cause deformation of the cap, which may result in failure to maintain intimate contact between the cap and the pouring hole 15 and/or which may facilitate movement of the cap inside the pouring hole 15. The present embodiment, however, involves using the adhesive tape 90, which is disposable, so as to successfully avoid such unfortunate situations.

The case joining step (step S3) involves welding the lid 14 to the peripheral edge of the opening of the case body 12. The case joining step (step S3) first involves, for example, placing the lid 14 such that an outer peripheral edge portion of the lid 14 is in alignment with an inner peripheral edge portion of the opening of the case body 12. The case joining step (step S3) then involves welding the outer peripheral edge portion of the lid 14 to the inner peripheral edge portion of the opening of the case body 12 across their entire circumferences. Welding in this case may be performed by a method known in the art (e.g., laser welding). The opening of the case body 12 is thus sealed, with the result that the case body 12 is integral with the lid 14. During laser welding, a high-temperature molten metal may be produced from a welding spot in the form of fine particles (i.e., spatters). The techniques disclosed herein, however, involve closing the pouring hole 15 with the adhesive tape 90, which makes it possible to prevent spatters from entering into the case body 12 through the pouring hole 15.

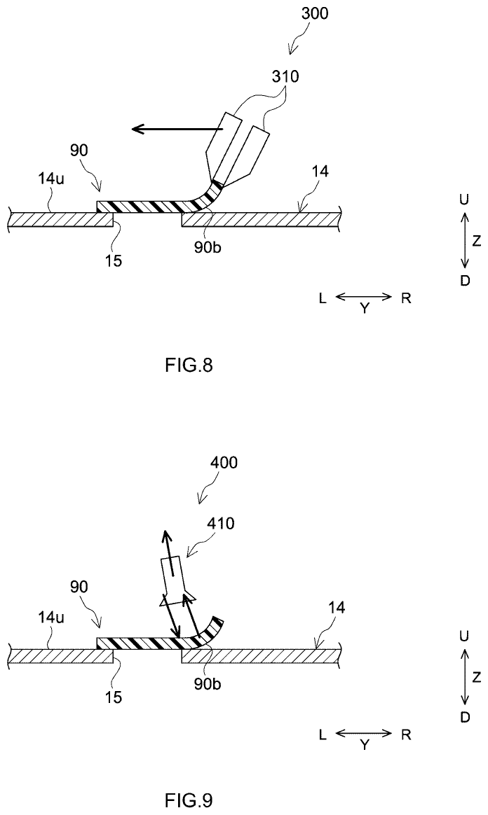

The unsealing step (step S4) involves peeling off the adhesive tape 90 affixed to the lid 14. Peeling off the adhesive tape 90 unseals the pouring hole 15. FIG. 8 is a schematic diagram illustrating the unsealing step (step S4). In the present embodiment, a gripper 300 to grip the adhesive tape 90 is first prepared in performing the unsealing step (step S4). The use of the gripper 300 improves productivity and/or workability of the unsealing step (step S4). The gripper 300 may be similar in structure, configuration, and/or arrangement to those commonly used and known in the art, or may be any other suitable gripper. In this embodiment, the gripper 300 includes a pair of thin plate blades 310. An end of each blade 310 is pointed toward the adhesive tape 90. This facilitates pulling up the adhesive tape 90. Alternatively, the adhesive tape 90 may be gripped with, for example, human fingertips and peeled off from the lid 14 without the use of the gripper 300.

As illustrated in FIG. 8, the unsealing step (step S4) subsequently involves inserting one of the blades 310 between the lid 14 and the portion of the adhesive tape 90 lifted from the lid 14 (i.e., the extended portion 90b) such that the extended portion 90b is sandwiched between the blades 310. The extended portion 90b of the adhesive tape 90 is thus gripped with the gripper 300. With the adhesive tape 90 gripped with the gripper 300, the gripper 300 is moved horizontally as indicated by the arrow in FIG. 8. This moves the adhesive tape 90 along the lid 14, causing the adhesive tape 90 to be peeled off from the lid 14, starting from the extended portion 90b. As just described, gripping the extended portion 90b with the gripper 300 facilitates peeling off the adhesive tape 90. Accordingly, an adhesive substance is more unlikely to remain around the pouring hole 15. The movement of the adhesive tape 90 along the lid 14 causes the adhesive tape 90 to be peeled off little by little in the long side direction Y and thus stabilizes the peeled off area of the adhesive tape 90, making it possible to reduce occurrence of nonuniform peeling.

The leak checking step (step S5) involves checking the hermeticity of the battery case 10. The leak checking step (step S5) may be performed by following a procedure known in the art. In one example, the battery case 10 is first filled with an inspection gas (e.g., helium gas) for leak checking through the pouring hole 15 that is unsealed. Then, an inspection device is used to detect leakage of the inspection gas from the battery case 10. This makes it possible to check whether there is leakage from the battery case 10 (e.g., leakage through the safety valve 17 and/or a joint between the case body 12 and the lid 14), and/or to identify leakage location(s).

The pouring step (step S6) involves pouring the electrolytic solution into the battery case 10. In this embodiment, the pouring step (step S6) involves pouring the electrolytic solution into the case body 12 through the pouring hole 15 of the lid 14. The electrolytic solution may be poured into the case body 12 under atmospheric pressure, or under reduced pressure inside the battery case 10, for example, with the aim of improving the impregnation of the electrode assembly 20 with the electrolytic solution. As a result, an assembled product (which is a combination of the battery case 10 and the electrode assembly 20) is fabricated. After the electrolytic solution has been poured into the case body 12, the assembled product may be left (or preserved) as it is for a predetermined period of time. This causes the electrolytic solution to spread in a balanced manner through the electrode assembly 20, for example, in the long side direction Y.

The final sealing step (step S7) involves sealing the pouring hole 15 with the sealing member 16. The final sealing step (step S7) preferably first involves causing gas inside the battery case 10 (e.g., air, or gas produced by decomposition of the electrolytic solution) to be discharged out of the battery case 10. The gas may be discharged out of the battery case 10 by, for example, reducing the pressure inside the battery case 10. The final sealing step (step S7) then involves fitting the sealing member 16 into the pouring hole 15, with the inside of the battery case 10 kept at normal pressure or the inside of the battery case 10 under reduced pressure. The final sealing step (step S7) subsequently involves welding the sealing member 16 to the pouring hole 15 such that the pouring hole 15 is sealed. As a result, the battery case 10 is sealed hermetically. The electricity storage device 100 is suitably manufactured through the steps described above.

The electricity storage device 100 is usable for various purposes. The electricity storage device 100 is suitably usable as a motor power source (e.g., a driving power source) to be installed on a vehicle, such as a plug-in hybrid electric vehicle (PHEV), a hybrid electric vehicle (HEV), or a battery electric vehicle (BEV). The electricity storage device 100 may be usable as a storage battery, such as a small electric power storage device. More than one electricity storage device 100 may be used in the form of a battery pack that typically includes more than one battery connected in series and/or in parallel.

Although the preferred embodiment of the present disclosure has been described thus far, the foregoing embodiment is only illustrative. The present disclosure may be embodied in various other forms. The present disclosure may be practiced based on the description given in this specification and technical common knowledge in the related field. The techniques described in the claims include various changes and modifications made to the embodiment illustrated above. Any or some of the technical features of the foregoing embodiment, for example, may be replaced with any or some of the technical features of variations of the foregoing embodiment. Any or some of the technical features of the variations may be added to the technical features of the foregoing embodiment. Unless described as being essential, the technical feature(s) may be optional.

In the foregoing embodiment, for example, the temporary sealing step (step S2) involves urging the adhesive tape 90 by moving the guide roller 211 upward as illustrated in FIG. 6D such that a portion of the adhesive tape 90 (i.e., the extended portion 90b) is lifted from the upper surface 14u of the lid 14. The temporary sealing step (step S2), however, may be performed in any other suitable manner. In one variation, a portion of the adhesive tape 90 may be lifted from the upper surface 14u of the lid 14 by using, for example, a curve made to the adhesive tape 90 while the adhesive tape 90 is wound around the feeding reel. In another variation, a portion of the adhesive tape 90 may be lifted from the upper surface 14u of the lid 14 by being bent by human hand. In still another variation, no adhesive layer may be provided on the extended portion 90b.

In the foregoing embodiment, for example, the unsealing step (step S4) involves gripping a portion of the adhesive tape 90 lifted from the lid 14 (i.e., the extended portion 90b) with the gripper 300 so as to peel off the adhesive tape 90. The unsealing step (step S4), however, may be performed in any other suitable manner.

FIG. 9 is a schematic diagram illustrating the unsealing step (step S4) according to one variation. In this variation, a suction device 400 is first prepared instead of the gripper 300. The use of the suction device 400 reduces the risk of damaging the lid 14. The suction device 400 may be similar in structure, configuration, and/or arrangement to those commonly used and known in the art, or may be any other suitable suction device. In this variation, the suction device 400 includes a sucker 410 and a mover (not illustrated). The sucker 410 is provided on a surface of the suction device 400 facing the adhesive tape 90 (i.e., a lower surface of the suction device 400 in FIG. 9). The sucker 410 is preferably smaller in outer shape than the extended portion 90b. Although not illustrated, the sucker 410 is provided with suction holes through which the adhesive tape 90 (or specifically, the extended portion 90b) is to be sucked. The suction holes are in communication with a suction pump (not illustrated). Suction operations of the suction device 400 are controlled by controlling the suction pump. Specifically, the suction device 400 starts sucking the adhesive tape 90 upon activation of the suction pump and stops sucking the adhesive tape 90 upon deactivation of the suction pump. The mover moves the sucker 410 toward the adhesive tape 90 and away from the adhesive tape 90. In this variation, the mover lowers and raises the sucker 410. The mover is, for example, a piston cylinder.

The sucker 410 is lowered by the mover such that the sucker 410 comes into abutment with a portion of the adhesive tape 90 lifted from the lid 14 (i.e., the extended portion 90b). In this state, activating the suction pump causes the extended portion 90b to be sucked onto the sucker 410 as indicated by the upward arrow in FIG. 9 that extends from the extended portion 90b. With the extended portion 90b sucked onto the sucker 410, the sucker 410 is moved upward or obliquely upward by the mover as indicated by the upward arrow in FIG. 9 that extends from the sucker 410. This raises the extended portion 90b together with the sucker 410 such that the adhesive tape 90 is peeled off from the lid 14, starting from the extended portion 90b. The pouring hole 15 may be unsealed in this manner.

As described above, specific embodiments of the techniques disclosed herein include those described in items below.

### Item 1

A method for manufacturing an electricity storage device including: an electrode assembly; an electrolytic solution; a case body including an opening and containing the electrode assembly and the electrolytic solution; and a lid including a pouring hole and closing the opening of the case body, the method including: a temporary sealing step involving affixing an adhesive tape to the lid such that the pouring hole is closed; and an unsealing step involving peeling off the adhesive tape affixed to the lid, wherein
the temporary sealing step involves affixing the adhesive tape to a peripheral edge of the pouring hole, and causing a portion of the adhesive tape located at a distance from the pouring hole to be at least partially lifted from the lid.

### Item 2

The method according to item 1, wherein
the adhesive tape has a rectangular shape, and
the temporary sealing step involves causing one end portion of the rectangular adhesive tape in a long side direction thereof to be lifted from the lid.

### Item 3

The method according to item 1 or 2, wherein
the temporary sealing step involves preparing a tape affixing apparatus including an affixing unit movable in a first direction extending along a surface of the lid,
the affixing unit includes: an affixing roller to press the adhesive tape against the surface of the lid; and a tape feeder disposed forward of the affixing roller in the first direction and configured to feed the adhesive tape to the affixing roller, and
the adhesive tape is sequentially fed from the tape feeder while the affixing unit is moved in the first direction, and the adhesive tape is affixed to the lid by an affixing operation that involves pressing the adhesive tape to the surface of the lid with the affixing roller.

### Item 4

The method according to item 3, wherein
the tape feeder includes a feeder mover that is able to move the tape feeder upward, and
after the affixing operation, the tape feeder is moved upward such that a portion of the adhesive tape located between the tape feeder and the affixing roller is urged to curl upward.

### Item 5

The method according to item 3 or 4, wherein
the affixing unit further includes a cutter to cut the adhesive tape, and
a portion of the adhesive tape located between the tape feeder and the affixing roller is cut with the cutter.

### Item 6

The method according to any one of items 3 to 5, wherein
the tape feeder includes: a guide roller to guide the adhesive tape to a position close to the affixing roller; a tape feeding path through which the adhesive tape is to be passed onto the guide roller; a suction arrangement which is provided on the tape feeding path and through which the adhesive tape is to be sucked; and a tape chuck provided on the tape feeding path and supporting the adhesive tape from below, and
the affixing operation involves moving the affixing unit in the first direction, with the suction arrangement deactivated and the tape chuck opened.

### Item 7

The method according to item 6, wherein
during the affixing operation, an angle formed between the tape feeding path and the lid is set to be between 20° and 50° inclusive.

### Item 8

The method according to any one of items 1 to 7, wherein
the unsealing step involves sucking the portion of the adhesive tape lifted from the lid in the temporary sealing step by using a suction device such that the adhesive tape is peeled off, starting from the lifted portion.

### Item 9

The method according to any one of items 1 to 7, wherein
the unsealing step involves gripping the portion of the adhesive tape lifted from the lid in the temporary sealing step such that the adhesive tape is peeled off, starting from the lifted portion.

### Item 10

The method according to item 9, wherein
the unsealing step involves moving the adhesive tape along the lid such that the adhesive tape is peeled off.

### Item 11

The method according to any one of items 1 to 10, further including a case joining step to be performed between the temporary sealing step and the unsealing step, the case joining step involving welding the lid to a peripheral edge of the opening of the case body.

### Item 12

The method according to any one of items 1 to 11, further including:
a pouring step involving pouring the electrolytic solution into the case body through the pouring hole after the unsealing step; and
a final sealing step involving sealing the pouring hole with a sealing member after the pouring step.

### REFERENCE SIGNS LIST

10 battery case
12 case body
14 lid
15 pouring hole
20 electrode assembly
90 adhesive tape
90a peripheral edge portion
90b extended portion
100 electricity storage device
210 tape feeder
211 guide roller
213 tape feeding path
214 tape chuck
220 tape affixer
221 affixing roller
230 tape cutting device
231 cutter
290 affixing unit
300 gripper
400 suction device
410 sucker

What is claimed is:

1. A method for manufacturing an electricity storage device including
an electrode assembly,
an electrolytic solution,
a case body including an opening and containing the electrode assembly and the electrolytic solution, and
a lid including a pouring hole and closing the opening of the case body, the method comprising:
a temporary sealing step involving affixing an adhesive tape to the lid such that the pouring hole is closed; and
an unsealing step involving peeling off the adhesive tape affixed to the lid, wherein
the temporary sealing step involves affixing the adhesive tape to a peripheral edge of the pouring hole, and causing a portion of the adhesive tape located at a distance from the pouring hole to be at least partially lifted from the lid.

2. The method according to claim 1, wherein
the adhesive tape has a rectangular shape, and
the temporary sealing step involves causing one end portion of the rectangular adhesive tape in a long side direction thereof to be lifted from the lid.

3. The method according to claim 1, wherein
the temporary sealing step involves preparing a tape affixing apparatus including an affixing unit movable in a first direction extending along a surface of the lid,
the affixing unit includes
an affixing roller to press the adhesive tape against the surface of the lid, and
a tape feeder disposed forward of the affixing roller in the first direction and configured to feed the adhesive tape to the affixing roller, and
the adhesive tape is sequentially fed from the tape feeder while the affixing unit is moved in the first direction, and the adhesive tape is affixed to the lid by an affixing operation that involves pressing the adhesive tape to the surface of the lid with the affixing roller.

4. The method according to claim 3, wherein
the tape feeder includes a feeder mover that is able to move the tape feeder upward, and
after the affixing operation, the tape feeder is moved upward such that a portion of the adhesive tape located between the tape feeder and the affixing roller is urged to curl upward.

5. The method according to claim 3, wherein
the affixing unit further includes a cutter to cut the adhesive tape, and
a portion of the adhesive tape located between the tape feeder and the affixing roller is cut with the cutter.

6. The method according to claim 3, wherein
the tape feeder includes
a guide roller to guide the adhesive tape to a position close to the affixing roller,
a tape feeding path through which the adhesive tape is to be passed onto the guide roller,
a suction arrangement which is provided on the tape feeding path and through which the adhesive tape is to be sucked, and
a tape chuck provided on the tape feeding path and supporting the adhesive tape from below, and
the affixing operation involves moving the affixing unit in the first direction, with the suction arrangement deactivated and the tape chuck opened.

7. The method according to claim 6, wherein
during the affixing operation, an angle formed between the tape feeding path and the lid is set to be between 20° and 50° inclusive.

8. The method according to claim 1, wherein
the unsealing step involves sucking the portion of the adhesive tape lifted from the lid in the temporary sealing step by using a suction device such that the adhesive tape is peeled off, starting from the lifted portion.

9. The method according to claim 1, wherein
the unsealing step involves gripping the portion of the adhesive tape lifted from the lid in the temporary sealing step such that the adhesive tape is peeled off, starting from the lifted portion.

10. The method according to claim 9, wherein
the unsealing step involves moving the adhesive tape along the lid such that the adhesive tape is peeled off.

11. The method according to claim 1, further comprising a case joining step to be performed between the temporary sealing step and the unsealing step, the case joining step involving welding the lid to a peripheral edge of the opening of the case body.

12. The method according to claim 11, further comprising:
a pouring step involving pouring the electrolytic solution into the case body through the pouring hole after the unsealing step; and
a final sealing step involving sealing the pouring hole with a sealing member after the pouring step.
